(19) United States
(12) Patent Application Publication
(10) Pub. No.: US 2017/0268482 A1
(43) Pub. Date: Sep. 21, 2017

(54) ROTOR BLADE FOR WIND TURBINES

(71) Applicant: NORDEX ENERGY GMBH, Hamburg (DE)

(72) Inventors: Lutz BEYLAND, Braunschweig (DE); Daniel NIES, Hamburg (DE)

(21) Appl. No.: 15/532,177

(22) PCT Filed: Dec. 3, 2015
(86) PCT No.: PCT/EP2015/078545

§ 371 Date: Jun. 1, 2017

(30) Foreign Application Priority Data
Dec. 5, 2014 (DE) 10 2014 118 004.6

(51) Int. Cl. F03D 1/06

(52) U.S. Cl. CPC F03D 1/0683; F03D 1/0675; F05B 2240/302; F05B 2260/301

(57) ABSTRACT

The invention relates to a segmented rotor blade for wind turbines, the segmented rotor blade having spar elements which can be telescoped into one another. According to the invention, in order to screw the telescoped spar elements together, one of the bushes is designed as a slide bush to achieve a better connection of the segmented rotor blades.

The invention relates to a segmented rotor blade for wind turbines, having at least two blade segments. The invention also relates to a wind turbine with a multi-blade rotor having such a segmented rotor blade.

The increasing development of renewable energies also increasingly puts the focus on the question of the efficiency of such renewable energy installations. Specifically in the field of wind turbines, it has been shown that increasing the size of the rotor blades provides a marked increase in the quantity of energy that can be extracted, which makes the use of such wind turbines more economically viable.

However, increasing the length of the rotor blades gives rise to the problem that transport to the construction site more often leads to high costs and in some cases is not possible at all. This is because, beyond a certain length of the rotor blades, these can no longer readily be transported on public infrastructure routes. One solution to this transport problem is provided by segmented rotor blades in which the rotor blade is broken down lengthwise into two or more segments. These segments are then transported separately and assembled only at the construction site.

Segmented rotor blades require a connection mechanism at their junction. A fundamental distinction can be drawn between adhesive-bonded and screw connections. Screw connections require a lot of additional material in the connection region in order to ensure that the screw connection can withstand the loads that it will experience. This gives rise to additional costs for segmented rotor blades.

WO 2010/023299 A2 discloses a segmented rotor blade which is assembled at its spars. For that purpose, in one segment the spar section protrudes beyond the junction and into the second segment, the spars being secured to one another with the aid of a screw connection. In this context, it is provided inter alia that the screw connection between the spars presses the spars against one another in a force fit, in order to thus achieve maximum stability and stiffness.

This has the drawback, in particular, that the components required for the screw connection have to be produced with great precision, since otherwise stresses can be produced in the components that can contribute to failure of the screw connection. However, such a level of tolerance is not always present, especially in the field of rotor blades made of fiber-reinforced polymers.

EP 2 288 807 B1 also discloses a segmented rotor blade in which, in one of the segments, the spar section likewise extends beyond the junction and into the other segment. The two segments are then screwed together by means of the spars, at the end faces of the spars, in order to thus achieve a force-fitting connection at the junction.

DE 31 09 566 C2 discloses a rotor blade for wind turbines, and clamping devices for assembly, wherein two rotor blade segments are held together by means of an expansion bolt.

DE 10 2008 055 513 A1 discloses a rotor blade for wind turbines which also consists of multiple segments, wherein the individual segments are assembled with the aid of an adhesive bond.

A considerable problem when joining segmented rotor blades using a screw connection lies in the fact that the bushings of the two spar sections, which participate in the screw connection, must be positioned with great precision in order that they line up exactly axially. Only by doing this is it possible to establish between the two rotor blade segments a play-free connection which can withstand the loads on a wind turbine in long-term operation. For this reason, in practice the openings required in the spars are produced in the assembled state in one step, which requires the individual segments to be assembled at least once during production of the rotor blade in order to be able to create the bores for the bushings. However, this has multiple drawbacks. For one, it requires a lot of space in the production hall, which has a negative effect on investment costs. Also, it requires another, time-consuming processing step, at the expense of productivity. Finally, the technique known from practice has the drawback that only those two blade segments that were drilled together will match, which means that the individual segments cannot be mass produced but rather can only ever be produced in pairs. This prevents variable interchange of the segments.

The present invention therefore has the object of specifying an improved segmented rotor blade in which the segments, including the bores required for a screw connection, can be produced separately from one another and the screw connection still establishes a secure, reliable and play-free connection between the two segments.

The object is achieved according to the invention with the features of claim 1.

This claim proposes a segmented rotor blade for wind turbines, having at least two blade segments, wherein the two or more blade segments, when assembled, form the final rotor blade for the wind turbine. The at least two blade segments have a junction whence they extend in opposite directions. The two blade segments are assembled at this junction, wherein the outer surface of each blade segment in the region of the junction matches that of the other so as to produce a smooth, continuous surface in the assembled state.

In that context, each blade segment has at least one spar element which forms a structural element of the rotor blade, in order to thus be able to appropriately take up and transmit the forces acting on the rotor blade.

A spar connector extends from the spar element of the first blade segment in the direction of the second blade segment and into a connection section of the spar element of the second blade segment in order to thus connect the blade segments to one another via the spar elements. The spar connector, also referred to as the spar bridge, then connect the two spar elements of the two blade segments in order to thus be able to securely and reliably connect the two blade segments to one another. In that context, the spar connector extends from the spar element of the first blade segment, over the junction in the direction of the second blade segment, wherein the spar connector reaches into a connection region of the spar element of the second blade segment. A form-fitting and/or force-fitting connection is then established in the connection region of the spar element of the second blade segment, for example by means of a screw connection, so that the spar connector is solidly connected to the spar element of the second blade segment. Since the spar connector is also solidly connected to the spar element of the first blade segment, this produces a solid connection between the spar elements of the first and second blade segments.

To that end, both the spar connector and the spar element of the second blade segment have in the connection region respective openings into which are introduced bushings for receiving at least one connection bolt, such that the connection bolt can pass through the respective bushings in order to connect the spar connector to the spar element of the second blade segment. For each connection bolt, preferably two connection bolts, corresponding openings and bushings are then in each case provided in the spar connector and in the spar element of the second blade segment.

It is now proposed, according to the invention, that at least one of the bushings is designed as a slide bushing which can move axially in the opening. This makes it possible to ensure tolerance compensation, thus making the segmented rotor blade less sensitive to manufacturing errors and also much easier to assemble. This is because designing one of the bushings as a slide bushing means that, even in the event of variations in the production process, the spar connector can still be connected to the spar element of the second blade segment not only in a form-fitting manner but also in a force-fitting manner since, when assembling the two blade segments and when accordingly establishing the screw connection, the sliding bushing is pressed axially against the next bushing of the respective element to be connected (spar connector or spar element of the second blade segment), such that in addition to a form-fitting connection by virtue of the bolt, there is also a force fit between the individual bushings of the respective connection bolt.

The slide bushing is thus configured in such a way that it is pressed, in the direction of the acting connection force, against the axially successive bushing and therefore bears in a force-fitting manner against the latter.

In that context, the spar elements can for example respectively consist of two opposing web sections which are connected to one another by two opposing flange sections, wherein the flange sections lie in the plane of rotation of the rotor blade. Thus, the web sections provide the stability of the rotor blade out of the plane of rotation, while the flange sections absorb the forces acting on the rotor blade in the plane of rotation. According to the invention, it is provided in this context that the openings are provided in the web sections of the spar element, wherein the spar connector can of course also be formed of webs and flange sections. It is thus possible, advantageously, for the connection of the two blade segments to be securely connected via their spars formed of web sections and flange sections, by means of a web screw connection.

The webs of a rotor blade primarily absorb the thrust forces that the wind exerts on the rotor blades. The flanges absorb what is referred to as the impact bending moment, which is also produced by the incident flow of the wind.

According to one advantageous embodiment, in particular with the embodiment that the spar elements consist of web sections and flange sections, the spar element of the second blade segment has, at least in the connection section, a cavity into which the spar connector extends in the assembled state of the two blade segments, wherein at least one bushing of the spar element of the second blade segment is designed as a slide bushing. Thus, when the two blade segments are fitted together, the spar connector is inserted into the cavity of the spar element of the second blade segment, wherein one of the bushings of the spar element of the second blade segment is then designed as a slide bushing, whereby, when the secure connection is established by means of the connection bolt, the slide bushing is moved axially in the direction of the cavity until it abuts against the bushing of the spar connector, where it is connected therewith in a force-fitting manner.

It is of course conceivable here for both bushings of the spar element of the second blade segment to be designed as slide bushings. In this case, when establishing the connection by means of the connection bolt, which can be designed as a connection screw, the spar connector is then connected to the slide bushings in a force fitting manner on both sides.

This makes it possible for the spar connector to be inserted into the cavity of the spar element of the second blade segment with a relatively loose fit when fitting together the two blade segments, wherein the slide bushing then serves to change the loose fit into a press fit after connection by means of the connection bolt. This substantially simplifies the assembly of the two blade segments while still permitting a solid and reliable screw connection. Furthermore, this type of connection is essentially insensitive to production errors.

According to one advantageous embodiment, the spar connector is part of the spar element of the first blade segment, and so the spar element of the first blade segment in the form of the spar connector extends into the connection section of the spar element of the second blade segment. In other words, the spar element of the first blade segment extends beyond the junction in the direction of the second blade segment. This makes it possible to create a corresponding spar-in-spar connection, which in particular also simplifies the production of the blade segments. The spar connector is thus integrally connected with the spar element of the first blade segment.

In another advantageous embodiment, the spar connector, extending in the direction of the connection section, narrows in that direction. In particular when the spar connector is designed as part of the spar element of the first blade segment, it is advantageous for the spar connector to narrow such that the flange sections flatten out on one side, and moreover possibly also such that the web sections narrow, which in particular permits improved and simplified assembly. In other words, the flange thickness decreases towards the end of the spar connector.

In another advantageous embodiment, into at least one of the openings there is introduced a clamping bushing which has a passage into which the respective bushing, in particular the slide bushing, is inserted. In that context, the clamping bushing is designed such that it can change the inner (and/or outer) diameter, and thus elements introduced into the opening of the clamping bushing can be connected in a force-fitting manner with the clamping bushing, and the clamping bushing itself can be braced in a bore. This achieves the advantage that, during connection of the connection bolt, all bushings can be connected in a force-fitting manner with the spar element of the second blade segment and/or with the spar connector, with the aid of the clamping bushing.

In this context, it is particularly advantageous if the slide bushing is inserted into the clamping bushing.

This makes it possible for the slide bushing to be at first guided in an axially movable manner in the clamping bushing, such that, when connecting by means of the connection bolt, the slide bushing can be pressed in a force-fitting manner against the axially subsequent bushing element, the slide bushing then being connected to the clamping bushing in a force-fitting manner such that the slide bushing is securely connected, via the clamping bushing, to the respective element, for example the spar connector or the spar element.

Alternatively, it is also conceivable that the slide bushing is held so as to be able to move axially in a flanged bushing inserted into the respective opening, it being for example advantageous to then secure the slide bushing by means of a threaded ring screwed on from the outside.

In another advantageous embodiment, at least one of the bushings has teeth which engage with teeth of a mating bushing in order to establish a form fit. Thus, it is for example conceivable for an outer bushing to have inward-pointing teeth that engage with teeth of an axially subsequent bushing of the element that is to be connected, whereby in addition to the force-fitting clamping the bushings are also connected in a form-fitting manner. This further prevents the blade segments sliding with respect to one another in the Z-direction.

Advantageously, the first blade segment is the tip blade segment while the second blade segment is the root blade segment.

It is also conceivable for the bushings, in particular the slide bushing, to be coaxial such that rotating the slide bushing in the respective opening makes it possible to compensate for tolerances in other directions and planes.

There follows an exemplary explanation of the invention with reference to the appended figures, in which:

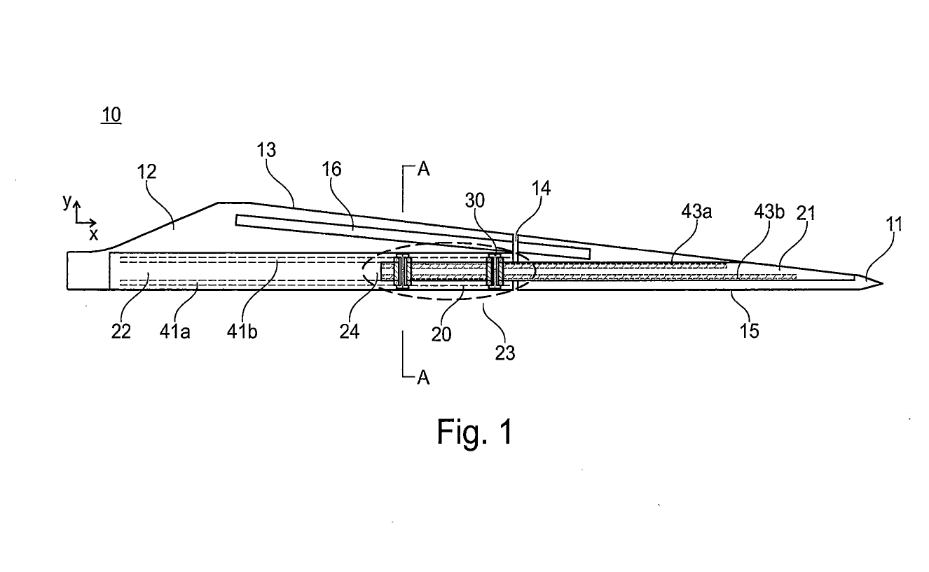

FIG. 1—is a schematic illustration of the segmented rotor blade;

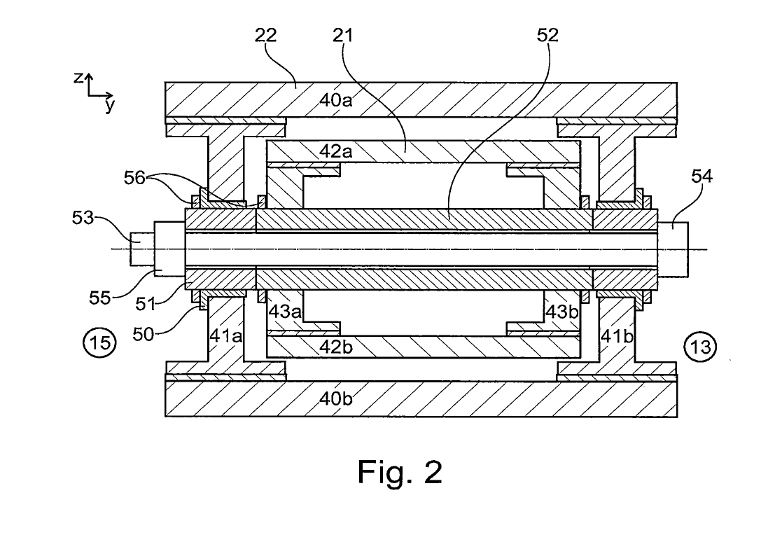

FIG. 2—shows a cross section of the screw connection in a first embodiment;

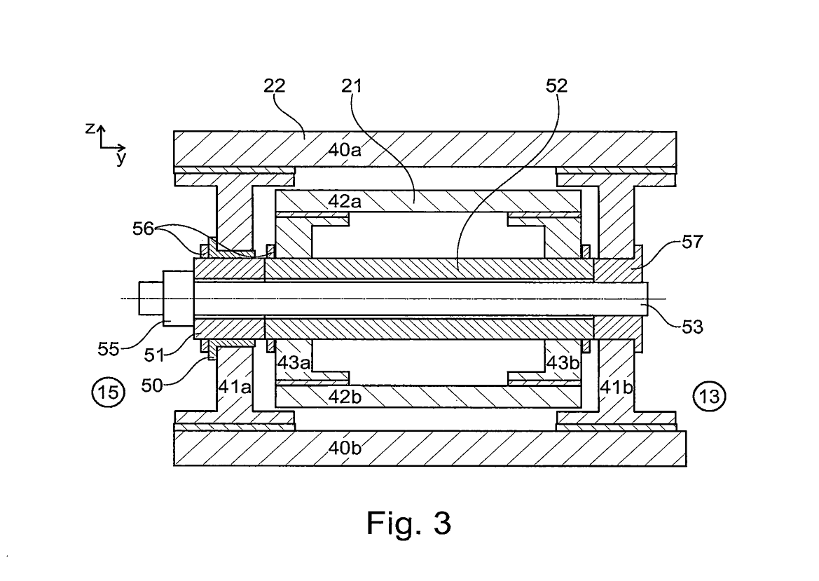

FIG. 3—shows a cross section of the screw connection in a second embodiment;

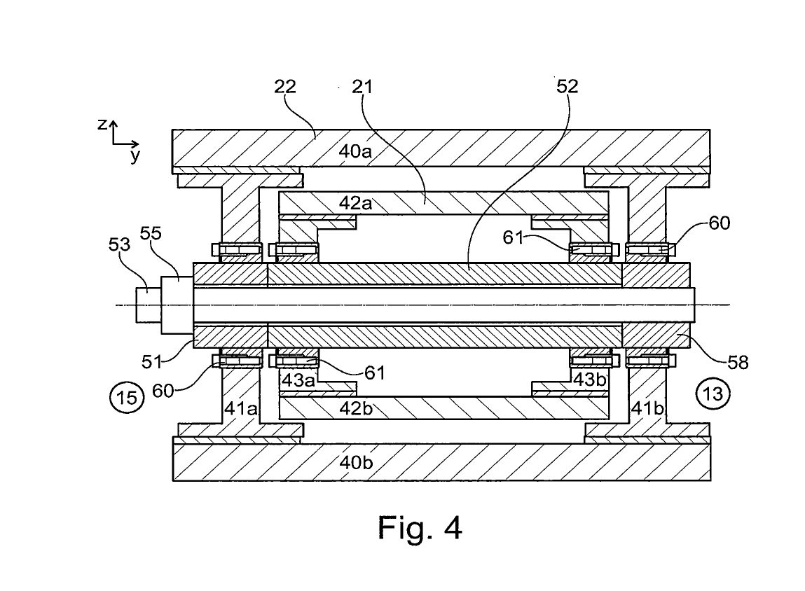

FIG. 4—shows a cross section of the screw connection in a third embodiment;

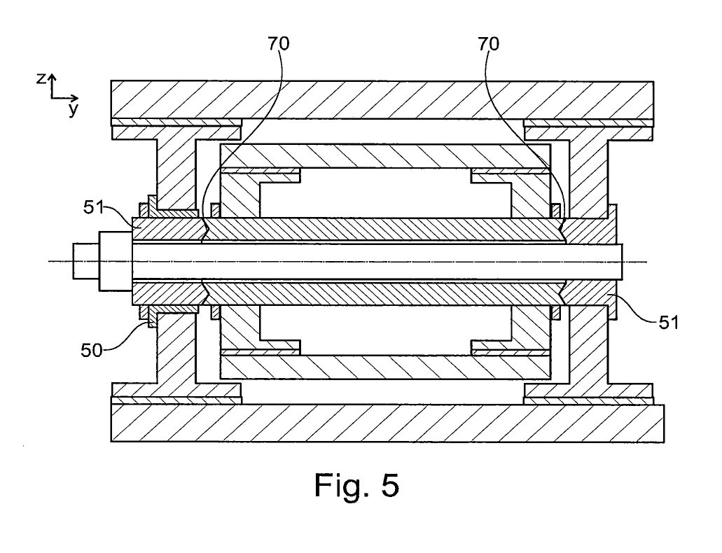

FIG. 5—shows a cross section of the screw connection in a fourth embodiment.

FIG. 1 shows, schematically and in a plan view, the segmented rotor blade 10 which has a first blade segment 11 and a second blade segment 12. Both blade segments 11 and 12 each have a respective spar element, 21 and 22, which together form a structural element of the rotor blade 10. A trailing edge strip 16, which stabilizes the rear portion of the rotor blade 10, can be provided at the trailing edge 13 of the rotor blade 10.

In that context, the two blade segments 11 and 12 are joined to one another at a junction 14, wherein the spar element 21 of the first blade segment 11 extends beyond the junction 14 in the direction of the second blade segment 12. The spar element 22 of the second blade segment 12 has a cavity 24 into which the spar element 21 of the first blade segment 11 extends. The spar element 21 of the first blade segment 11 extends into the connection region 23 of the second blade segment 12, in which the spar element 21 of the first blade segment 11 is connected to the spar element 22 of the second blade segment 12 by means of a screw connection 30.

FIGS. 2 to 4 now explain the screw connection 30 of FIG. 1 in the cross section A-A. FIG. 2 shows, in the cross section of the screw connection 30, the inner spar element 21 of the first blade segment 11 which is inserted into the cavity of the outer spar element 22 of the second blade segment 12. Both the inner spar element 21 and the outer spar element 22 are formed of opposing web sections that are connected to one another by flange sections. Thus, the outer spar element 22 has an upper flange section 40a and a lower flange section 40b which connects the two web sections 41a and 41b to one another. The inner spar element 21 is formed in a corresponding manner. In that context, the web section 41a is oriented toward the leading edge 15 while the web section 41b is oriented toward the rotor blade trailing edge 13. The flange sections 40a and 40b lie in the plane of rotation of the rotor blade.

In the web sections 41a, 41b, 43a, 43b of the spar elements 21, 22, openings are provided in the region of the screw connection, into which openings are inserted, according to the invention, bushings of which at least one is a slide bushing.

In the exemplary embodiment of FIG. 2, a flanged bushing 50 is first provided in the openings in the web sections 41a, 41b of the spar element 22 (the outer spar element), which flanged bushing 50 is designed to receive the slide bushing 51. In the spar element 21 (the inner spar element) there is provided, in the openings of the web sections 43a, 43b, a through-bushing 52 which is axially aligned with the opening of the slide bushing 51 of the outer spar element 22. This axial alignment now permits the passage of a connection bolt 53 which is for example designed as a screw. On one side, the screw has a screw head 54 and, at the other end, a thread onto which a nut 55 is screwed.

Owing to the fact that the slide bushing 51 is guided such that it can move axially in the flanged bushing 50, establishing the screw connection with the nut 55 exerts a force in the direction of the inner spar element 21, which presses the slide bushing 51 against the through-bushing 52 of the inner spar element 21. Thus, the outer bushings 51 of the outer spar element are pressed against the inner through-bushing 52, producing a force-fitting connection between the slide bushings 51 and the through-bushing 52 at this point.

The slide bushings are fixed axially by means of a threaded ring 56 which is screwed onto both slide bushings 51, in order to thus be able to absorb forces in the Y-direction.

FIG. 3 shows an exemplary embodiment in which only the bushing of that web section 41a of the spar element 22 that is oriented toward the blade leading edge 15 is designed as a slide bushing 51. At the opposite web section 41b, which is oriented toward the blade trailing edge 13, a flanged bushing 57 with an internal thread is introduced into the web section 41b such that it is possible to dispense with the screw head 54 of FIG. 2. Thus, when connecting the two blade segments, the screw 53 is screwed into the flanged bushing 57, wherein tightening the nut 55 then causes a force to act in the direction of the flanged bushing 57, whereby the slide bushing 51 is pressed against the through-bushing 52. Thus, the inner spar element 21 with a through-bushing 52 is also pressed against the flanged bushing 57 with the internal thread, thus ultimately producing a force-fitting connection between the respective bushings.

In both variants of FIG. 2 and FIG. 3, the fit between the slide bushing and the flanged bushing is a snug clearance fit, e.g. h7/h6, such that a changing impact bending moment gives rise to only a very small movement in the Z-direction. This play can possibly be eliminated entirely by firm tightening of the threaded ring.

The variant of FIG. 2 has the advantage that the screw connection has more play since all of the bushings have through-bores. Thus, any errors can be better intercepted. Furthermore, assembly is simpler if the connection is accessible and visible from both sides.

The variant of FIG. 3 has the advantage that the rotor blade shell at the trailing edge is no longer simply interrupted. In particular, the trailing edge strip contained therein experiences relatively high loads which thus do not have to be transmitted multiple times.

FIG. 4 shows an exemplary embodiment in which the slide bushing 51 and the through-bushing 52 of the inner spar element 21 are guided in a clamping bushing 60, 61. Another particular feature of the exemplary embodiment of FIG. 4 is that the slide bushing 58 has an internal thread at the trailing edge 13, such that the connection bolt or the connection screw 53 can be screwed into this slide bushing with the internal thread 58.

The provision of clamping bushings 60, 61 has the advantage that the slide bushings 51, and/or the through-bushing 52, are/is axially variable such that in particular production errors can be much better compensated for. This is because the clamping bushings 60, 61 make it possible to bring about two states, namely on one hand the state in which the respective bushings can move axially in the clamping bushings, and on the other hand the second state in which the clamping bushings are clamped in a force-fitting manner with the respective bushings therein.

It is however also conceivable, in a simplified embodiment, that only one of the bushings is guided in a clamping bushing, such that, once the force-fitting connection between the bushings has been established, with the aid of the clamping bushing 60, the corresponding slide bushing can be connected in a force-fitting manner.

Furthermore, the exemplary embodiment of FIG. 5 provides that the bushings have teeth 70 that engage with respectively matching teeth of the adjacent bushing such that, in addition to the force-fitting clamping, the bushings are also connected in a form-fitting manner. This additionally secures against the blade segments moving with respect to one another in the Z-direction. Thus, in the exemplary embodiment of FIG. 5, it is provided that the slide bushing 51 of the web section 41a has teeth 70 which engage with teeth of the through-bushing 52, the flanged bushing 57 of the web section 41b also having teeth 70 which engage with the teeth of the through-bushing 52 on that side.

The flanged bushings 50 can for example be adhesively bonded in the web sections 41a, 41b in order to thus permit a solid connection. Furthermore, the through-bushing 52 of the inner spar element 21 can also be adhesively bonded in the respective web sections 43a, 43b.

In order to achieve as high a weight-saving potential as possible, it is advantageous if both blade segments are made of a fiber-reinforced composite material, or at least comprise such a material.

### LIST OF REFERENCE SIGNS

10 segmented rotor blade
11 first blade segment
12 second blade segment
13 trailing edge
14 junction
15 leading edge
16 trailing edge strip
20 spar connector
21 spar element of the first blade segment
22 spar element of the second blade segment
23 connection region
24 cavity of spar element 22
30 screw connection
40a, 40b—flange section of spar element 22
41a, 41b—web section of spar element 22
42a, 42b—flange section of spar element 21
43a, 43b—web section of spar element 21
50 flanged bushing
51 slide bushing
52 through-bushing
53 connection bolt/screw
54 screw head
55 nut
56 threaded ring
57 flanged bushing with internal thread
58 slide bushing with internal thread
60, 61 clamping bushing
70 teeth

1. A segmented rotor blade for wind turbines, comprising:
at least two blade segments which extend in opposite directions from a junction, wherein each blade segment comprises at least one spar element which forms a structural element of the rotor blade;
a spar connector extending from a first spar element of a first blade segment in a direction of a second blade segment and into a connection section of a second spar element of the second blade segment and connecting the first and second blade segments of the at least two blade segments to one another via the first and second spar elements,
wherein openings in the spar connector and the second spar element of the second blade segment include one or more bushings for receiving at least one connection bolt,
wherein the connection bolt passes through the one or more bushings and connects the spar connector to the second spar element of the second blade segment,
wherein at least one of the one or more bushings is a slide bushing which can move axially in the opening in the spar connector and/or the second spar element.

2. The rotor blade as claimed in claim 1, wherein the first and second spar elements each have two opposing web sections which are connected to one another by two opposing flange sections, wherein the flange sections lie in a plane of rotation of the rotor blade, and wherein the openings are provided in the web sections of the first and second spar element.

3. The rotor blade as claimed in claim 1, wherein the second spar element of the second blade segment has, at least in a connection section, a cavity into which the spar connector extends in the assembled state of the at least two blade segments, wherein at least one bushing of the second spar element of the second blade segment is the a slide bushing.

4. The rotor blade as claimed in claim 3, wherein the slide bushing the second spar element of the second blade segment bears with a force fit against the bushing of the spar connector when the spar connector (20) is connected to the second spar element of the second blade segment by the connection bolt.

5. The rotor blade as claimed in claim 1, wherein the spar connector extends into a connection section of the second spar element of the second blade segment.

6. The rotor blade as claimed in claim 1, wherein the spar connector narrows in a direction of an extending connection section.

7. The rotor blade as claimed in claim 1, wherein at least one of the openings has a clamping bushing which has a passage into which another bushing is inserted.

8. The rotor blade as claimed in claim 7, wherein the slide bushing is inserted into the clamping bushing such that, when connecting the at least two blade segments, the slide bushing is held in the clamping bushing so that it can move axially, and such that, once the at least two blade segments are connected by the connection bolt, the slide bushing is seated with a force fit in the clamping bushing.

9. The rotor blade as claimed in claim 1 wherein the slide bushing is held so as to be able to move axially in a flanged bushing inserted the opening in the spar connector and/or the second spar element.

10. The rotor blade as claimed in claim 1 wherein at least one of the bushings has teeth which engage with teeth of a mating bushing.

11. A wind turbine with a multi-blade rotor having at least one rotor blade as claimed in claim 1.
